(19) United States
(12) Patent Application Publication
(10) Pub. No.: US 2022/0396493 A1
(43) Pub. Date: Dec. 15, 2022

(54) METHOD OF MAKING PURIFIED PRECIPITATED CALCIUM CARBONATE FROM LIME MUD

(71) Applicant: Specialty Minerals (Michigan) Inc., Bingham Farms, MI (US)

(72) Inventors: Sherman Cox, Bingham Farms, MI (US); Mark Daigle, Bingham Farms, MI (US); Timothy Sammarco, Bingham Farms, MI (US)

(21) Appl. No.: 17/771,263

(22) PCT Filed: Oct. 16, 2020
(86) PCT No.: PCT/US2020/056012

§ 371 Date: Apr. 22, 2022

Related U.S. Application Data
(60) Provisional application No. 62/924,563, filed on Oct. 22, 2019.

(51) Int. Cl. C01F 11/18

(52) U.S. Cl. CPC C01F 11/185

(57) ABSTRACT

A method of making a purified precipitated calcium carbonate from lime mud can include admixing a lime mud cake with water and sodium carbonate to form a first slurry; heating the first slurry under conditions to age the slurry and form one or more of pirssonite, shortite, and gaylussite; separating a solid portion from the aged slurry; washing the solid portion under conditions sufficient to decompose the one or more of pirssonite, shortite, and gaylussite to a CaCO₃ solid fraction and Na₂CO₃ solid fraction and to remove sodium salts; and admixing the CaCO₃ solid fraction with water and a dispersant to disperse the CaCO₃ solid fraction in water and form a dispersed slurry having a Brookfield viscosity of less than about 1000 cps at 100 rpm, thereby producing a dispersed slurry containing the purified precipitated calcium carbonate.

### BACKGROUND

### Field of the Disclosure

The disclosure generally relates to methods of treating lime mud cake generated as a waste product to produce a precipitated calcium carbonate, and particular to methods for treating a lime mud cake generated as a waste product to produce a precipitated calcium carbonate suitable for use as filler and/or pigments in paper and paperboard.

### BRIEF DESCRIPTION OF RELATED TECHNOLOGY

The main component in paper and paperboard is a cellulosic pulp fiber that is produced from wood or other plant sources by a variety of mechanical and/or chemical pulping processes. A predominate chemical pulping process used in the paper industry is the alkaline “kraft” process, which uses sodium hydroxide (caustic soda), and sodium sulfide, in a digestion process step to extract and separate non-cellulosic materials from cellulosic pulp fibers. Another common variation in pulping, among others, is without sodium sulfide and this is known as caustic pulping.

In order to maximize operational and economic efficiency of the pulping process, chemicals are recovered and reused as much as possible. In this chemical recovery process, some pulping operations include a lime kiln. The lime kiln functions to produce lime (CaO) that is combined (slaked) with “green liquor” in a process called causticization. The green liquor originates in the pulping process between pulping and causticization. If no lime kiln is present, commercial lime (CaO) is purchased and used in a single pass through causticization circuit.

The main chemical constituent of the green liquor is sodium carbonate, and the reaction of lime with sodium carbonate produces sodium hydroxide (caustic soda) and calcium carbonate (CaCO₃) via the following reaction steps:

CaO+H₂O→Ca(OH)₂ (1)

Ca(OH)₂+Na₂CO₃→CaCO₃+2NaOH (2)

The calcium carbonate produced in step 2 is referred to in the industry as “lime mud,” while the sodium hydroxide (caustic soda) solution is referred to as the “white liquor.” The reaction conditions in step 2 cause the lime mud to precipitate as relatively large particles that can be quickly separated from the white liquor stream. After washing and filtration, the lime mud is either recycled back to the lime kiln, if present, or disposed of in a landfill. In practice, systems often include both recycled and some purged lime mud that is landfilled.

Paper and paperboard products often include calcium carbonate either as fine particles produced from ground limestone or synthetically precipitated as fillers and/or coating pigments because of its inherently superior whiteness and brightness compared to other mineral pigments. Despite containing calcium carbonate, lime mud is generally unsuitable for use as fillers and/or coating pigments in paper and paperboard. Lime mud has relatively low whiteness and brightness. Further, lime mud has generally large particle sizes and elevated pH due to residual caustic soda. Lime mud produced from pulping non-wood species, such as reed and straw, often contains elevated levels of high surface area siliceous minerals, which increase the specific surface area of the lime mud particles and render them unsuited for use as fillers in conventional papermaking.

Another detriment of lime mud is that black particles of char may become intermixed with the lime mud particles. The black char can originate from combustion in the recovery boiler, which can be carried into the green liquor and ultimately into the lime mud produced from the causticization of the green liquor. Black char, which can result in black spots, are highly undesirable in a white pigment intended for use in paper. For these reasons, lime mud is disposed in a landfill when it is not re-burned in a lime kiln to produce calcium oxide (CaO) for re-use in the causticization step. Even when lime mud is recycled, it may be advantageous to purge more lime mud in order to (i) increase pulping capacity, (ii) or cleanup the system of non-process elements and improve process efficiency.

### SUMMARY

It would be advantageous if lime mud could be processed to make it suitable for use as fillers and/or coating pigment for paper and paperboard as opposed to being landfilled. It would also improve the total utilization of lime purchased by a paper mill and reduce its consumption of purchased mineral filling and/or coating pigments. Additionally, refining of this lime mud into a viable new product supports global efforts by companies supporting a circular economy where waste is minimized and resource use is more efficient through the re-use, recycle, or repurposing of materials.

In accordance with embodiments of the disclosure, a method of making a purified precipitated calcium carbonate from lime mud can include admixing a lime mud cake with water and sodium carbonate to form a first slurry; heating the first slurry under conditions to age the slurry and form one or more of pirssonite, shortite, and gaylussite; separating a solid portion from the aged slurry; washing the solid portion under conditions sufficient to decompose the one or more of pirssonite, shortite, and gaylussite to a CaCO₃ solid fraction and Na₂CO₃ solid fraction and to remove sodium salts; and admixing the CaCO₃ solid fraction with water and a dispersant to disperse the CaCO₃ solid fraction in water and form a dispersed slurry having a Brookfield viscosity of less than about 1000 cps at 100 rpm, thereby producing a dispersed slurry containing the purified precipitated calcium carbonate.

In accordance with embodiments of the disclosure, a method for making a purified precipitated calcium carbonate from lime mud can include admixing a lime mud cake with water and a dispersant to form a first slurry having a Brookfield viscosity of less than about 1000 cps at 100 rpm; milling the first slurry to a median particle size of about 0.4 microns to about 5 microns; phase separating the milled slurry under conditions sufficient to obtain a centrate slurry comprising impurity particles and a paste comprising a purified calcium carbonate; and diluting the paste in water to a target solids content to thereby produce a dispersed slurry containing the purified precipitated calcium carbonate.

In accordance with embodiments of the disclosure, a method for making a purified precipitated calcium carbonate from lime mud can include admixing a lime mud cake with water to form a first slurry; adjusting the pH of the first slurry to be about 10 to about 11; centrifuging the first slurry under conditions sufficient to achieve a g-force of about 500 to about 2000 g for a residence time of about 1 to about 10 minutes to obtain a centrate slurry comprising impurity particles and a paste comprising a purified calcium carbonate; and admixing the paste with water and a dispersant to form a dispersed slurry having a Brookfield viscosity of less than about 1000 cps at 100 rpm and containing the purified precipitated calcium carbonate.

In accordance with embodiments of the disclosure, a method for making a purified precipitated calcium carbonate from lime mud, admixing a lime mud cake with water to form a first slurry; adjusting the pH of the first slurry to be about 8 to about 11; admixing the first slurry with a silicate flotation collector compound to form a second slurry; processing the second slurry through a flotation cell system under conditions sufficient to form a concentrate foam containing silicate particle impurities and a tail slurry containing CaCO₃; washing and separating the tail slurry into a liquid phase containing excess soluble salts and a paste containing purified CaCO₃; and admixing the paste with water to form a dispersed slurry having a viscosity of less than about 100 cps at 100 rpm and containing the purified precipitated calcium carbonate.

In accordance with embodiments of the disclosure, a method of removing black char from a starting slurry containing calcium carbonate and black char, can include flowing a starting slurry into a first hydrocyclone under conditions sufficient to cause black char particles to rise to a top portion of and form a first overflow and the calcium carbonate to remain at a bottom portion to form a first underflow; flowing the first underflow to a second hydrocyclone under conditions sufficient to cause black char particles to rise to a top portion and form a second overflow and the calcium carbonate to remain at a bottom portion to form a second underflow; flowing the first overflow to a third hydrocyclone under conditions sufficient to cause black char particles to rise to a top portion and form a third overflow and the calcium carbonate to remain at a bottom portion to form a third underflow; flowing the second underflow to a recovery chamber; flowing the second overflow to the first hydrocyclone; flowing the third underflow to the first hydrocyclone; flowing the third overflow to a fourth hydrocyclone under conditions sufficient to cause black char particles to rise to a top portion and form a fourth overflow and the calcium carbonate to remain at a bottom portion to form a fourth underflow; flowing the fourth overflow to a waste container; and flowing the fourth underflow to the third hydrocyclone.

In accordance with embodiments of the disclosure, a method of removing black char from a starting slurry containing calcium carbonate and black char, can include flowing a starting slurry into a hydrocyclone under conditions sufficient to cause black char particles to rise to a top portion of and form an overflow and the calcium carbonate to remain at a bottom portion to form an underflow; flowing the overflow to waste; and flowing the underflow to a recovery chamber.

In accordance with embodiments of the disclosure, a method of removing black char from a starting slurry containing calcium carbonate and black char, can include flowing a starting slurry into a first hydrocyclone under conditions sufficient to cause black char particles to rise to a top portion of and form a first overflow and the calcium carbonate to remain at a bottom portion to form a first underflow; flowing the first underflow to a second hydrocyclone under conditions sufficient to cause black char particles to rise to a top portion and form a second overflow and the calcium carbonate to remain at a bottom portion to form a second underflow; flowing the first and second overflows to waste; and flowing the second underflow to a recovery chamber.

In accordance with embodiments of the disclosure, a method of removing black char from a starting slurry containing calcium carbonate and black char, can include loading the starting slurry into a trap tank using a continuous inflow at or near a center of the trap tank; agitating the starting slurry in the trap tank using an agitator at a tip speed of about 0.1 m/sec to about 1.5 m/sec for a residence time of about 4 to about 10 min and under conditions sufficient to cause black char particles to rise to a top portion of the trap tank and calcium carbonate to settle to a bottom portion of the trap tank; and pumping the calcium carbonate from the bottom portion of the trap tank to a recovery container.

In accordance with embodiments of the disclosure, a method of removing black char from a starting slurry containing calcium carbonate and black char, can include flowing an ozone containing gas through the starting slurry at a flow rate per liter of starting slurry of about 0.1 liters per min to about 2 liters per min with an agitator at a tip speed of about 1 m/sec to about 5 m/sec, wherein the black char is oxidized by the ozone to carbon dioxide gas and removed with a gas flow.

In accordance with embodiments of the disclosure, a method of removing black char from a starting slurry containing calcium carbonate and black char, can include admixing the starting slurry with a frother and a flotation collector compound to form a second slurry; processing the second slurry through a flotation apparatus under an air flow per liter of second slurry of about 1 slpm to about 3 slpm and with an agitator at tip speeds of about 150 m/min to about 500 m/min for about 1 min to about 10 min, a foam which overflows from the flotation apparatus and a tail slurry which remains in the flotation apparatus, the foam comprising the black char and the tail slurry comprising the calcium carbonate; and collecting the tail slurry and dispersing the tail slurry in water to form a dispersed slurry containing the calcium carbonate.

In any of the foregoing embodiments of methods of removing black char, the starting slurry can a slurry of a purified precipitated carbonate product. For example, the starting slurry can be a slurry of a purified precipitated carbonate product resulting from any of the methods disclosed herein.

### BRIEF DESCRIPTION OF THE DRAWINGS

FIG. 1A is a schematic illustration of a trap tank in accordance with embodiments of the disclosure;

FIG. 1B is a schematic illustration of a trap tank in accordance with embodiments of the disclosure;

FIG. 2 is a simplified flow scheme showing four hydrocyclones for removing black char in the rejects.

FIG. 3 shows field emission scanning electron microscope images of a lime mud sample at two magnifications. The higher magnification shows how the impurities (platy and very fine particles) are embedded within the calcium carbonate agglomerate.

### DETAILED DESCRIPTION

Methods of treating lime mud in accordance with embodiments of the disclosure can include a series of chemical and mechanical treatments. Methods in accordance with the disclosure process the lime mud waste product into particles of suitable size and purity for use as filler and/or pigments in paper and paperboard products and remove undesirable inorganic species such as mineral silicates and black carbonaceous material. Precipitated calcium carbonate that is generally suitable for use as a filler or pigment can have one or more of a median particle size distribution of about 0.5 μm to about 5 μm, a specific surface area of about 3 m²/g to about 20 m²/g, an ISO brightness of greater than about 80, and no visible black char. Unless otherwise specified, herein, a median particle size distribution of resulting precipitated calcium carbonate is measured using a laser light scattering instrument, such as the Horiba LA-950. Sample preparation for particle size measurement involves mixing with a dispersant polymer such as a poly(acrylic acid) followed by sonication.

Methods of making precipitated calcium carbonate from lime mud in accordance with the disclosure can include one or both of removal of impurities having high specific surface area and removal of visible black char. Methods of making precipitated calcium carbonate by removal or reduction of impurities having high specific surface area and removal of visible black char can include a two-step process. In embodiments, the methods of the disclosure can remove high specific surface area materials to result in a purified precipitated calcium carbonate. In embodiments, the methods can include further processing the resulting purified precipitated calcium carbonate to remove visible black char for further refinement of the purified precipitated calcium carbonate. In embodiments, the methods of the disclosure can remove black char to result in a purified precipitated calcium carbonate.

High specific surface area impurities can include one or more of silicates, calcium silicate hydrates, hydrotalcite-like compounds, calcium aluminates, calcium phosphates, and amorphous silicates. By high specific surface area, it is generally meant impurities particles having specific surface areas of greater than 20 m²/g. For example, high specific surface area materials can have a surface area of greater than 20 m²/g to 100 m²/g or more. For example, typical surface areas of such high surface area materials is about 40 m²/g to about 60 m²/g.

Black char is a black carbonaceous material that can be present in the lime mud. Depending on the source of the lime mud, it may be necessary to process the lime mud for both removal of high specific surface area impurities and black char. Alternatively, only removal of black char may be necessary. When used in combination with methods of removal of high specific surface area materials, the removal of black char can be performed after the removal of the high specific surface area materials. Generally, removal of black char is performed to the point at which there is no remaining visible black char.

Embodiments of the disclosure include removal of high specific surface area impurities by one or more flotation cell methods, heat aging methods, and phase separation methods. Embodiments of the disclosure can separately or additionally include removal of visible black char by one or more of hydrocyclone methods, trap tank methods, ozone methods, and flotation methods. Any suitable combination of any one or more high specific surface area impurity removal methods and any one or more of visible black char removal methods can be utilized.

In any of the methods of the disclosure, the lime mud cake can be generated as a waste product in a number of processes, such as a paper kraft pulp mill, sugar beet production, and the byproduct of acetylene production. The lime mud can be the reaction product of reacting lime and green liquor from recovery boiler smelt. The smelt can come from burning kraft process black liquor or soda process (NSSC) black liquor or from chemi-mechanical pulping liquors (CMP, CTMP, APMP).

In any of the methods disclosed herein, the lime mud cake can be washed by admixing the lime mud cake with water to form a first slurry and washing first slurry to remove caustic soda present in the lime mud cake.

In any of the methods of the disclosure where pH adjustment is performed, the pH can be reduced by flowing carbon dioxide gas and/or a carbon dioxide containing gas through the slurry. For example, a stack gas can be used. Other suitable gases include pure carbon dioxide gas such as from a liquefied source, dilute combustion flue gasses, by products of carbon dioxide from ethanol or petrochemical sources. Stack gasses can be from boilers or kilns with carbon dioxide contents from about 8% to about 30%.

In any of the methods of the disclosure where milling is performed, milling can be accomplished by any known suitable methods for fine grinding. For example, the slurry can be milled by various known milling techniques such as ball mill, sand mill, and media mill. For example, the slurry can be milled using a vertically or horizontally agitated media mill using glass, sand and/or ceramic media. The media can have median diameters from about 0.5 mm to about 3 mm. The slurry is milled to particle sizes suitable for the anticipated end use. For example, in treating the lime mud to form precipitated calcium carbonate, the methods of the disclosure can include milling to a median particle size of about 0.5 microns to about 5 microns, about 1 micron to about 2 microns, about 0.5 microns to about 1 micron, about 3 microns to about 5 microns, or about 2 microns to about 3 microns. Suitable sizes include median particle sizes of about 0.5, 1, 1.5, 2, 2.5, 3, 3.5, 4, 4.5, and 5 microns.

### Flotation Cell Method

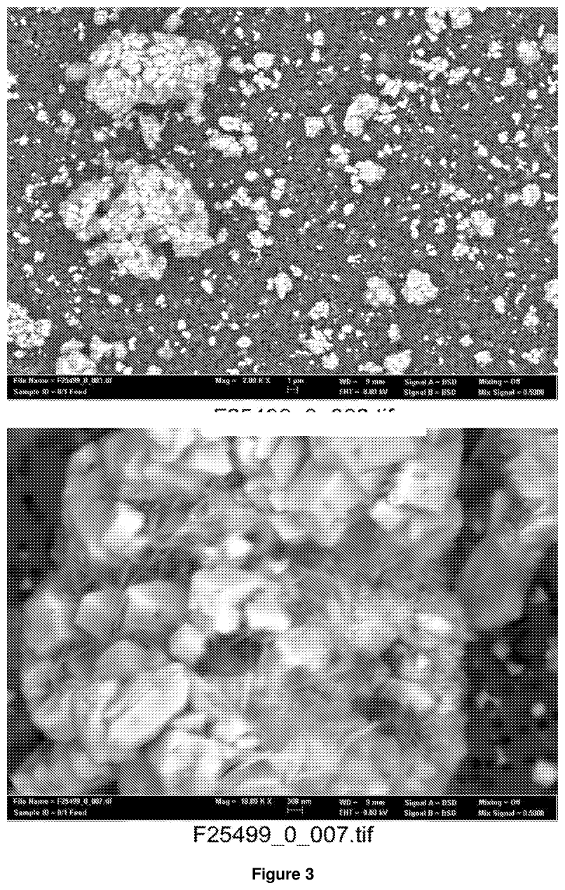

In embodiments, a method for making precipitated calcium carbonate from lime mud can include the use of a flotation cell to remove high specific surface area impurities from the lime mud. Flotation cell technology is commonly used for removal of larger particle size impurities having an average particle size of about 50 to 500 microns. It has been advantageously found that methods in accordance with the disclosure can allow for the use of float cell technology for removal of smaller particle size impurities, such as particle sizes of from 4 to 20 microns. Referring to FIG. 3, high surface area materials are generally bound together with calcium carbonate crystals as an agglomerate. It was surprisingly found that separation of such impurities could be achieved by the flotation cell methods of the disclosure despite this agglomeration. A skilled person would not have expected the ability to separate such an agglomeration without also removing or adversely affecting the calcium carbonate using conventional flotation cell technology or even centrifugation.

The method can include admixing the lime mud cake with water to form a first slurry and adjusting the pH to be about 8 to about 11, or about 9 to about 10.5, or about 8 to about 10 or about 8 to about 11. Other suitable pH values include about 8, 8.5, 9, 9.5, 10, 10.5, and 11. The first slurry can then be admixed with a silicate flotation collector compound to form a second slurry and the second slurry can be diluted with water to a solids content of about 5% to about 15% by weight based on the total weight of the second slurry. Alternatively, a solids content of about 5% to about 15% by weight based on the total weight of the slurry can be achieved by performing a dilution at the time of mixing the lime mud cake with water to form the first slurry.

The second slurry can then be processed through a flotation cell system under conditions sufficient to form a concentrate foam containing silicate particle impurities and a tail slurry containing CaCO₃.

The tail slurry can be washed and separated into a liquid phase containing excess soluble salts and a paste containing purified CaCO₃. The paste can be admixed with water and dispersant to form a dispersed slurry having a viscosity of less than about 1000 cps at 100 rpm.

A purified precipitated calcium carbonate product results in the dispersed slurry. If needed for a particular application, the dispersed slurry can be milled to a median particle size of about 0.5 microns to 5 microns and/or the pH can be adjusted to be about 9 to about 10.5 if the pH is outside this range after milling.

In embodiments, the first slurry having the silicate flotation collector compound can be admixed to a solids content of about 5% to about 40% by weight based on the total weight of the slurry. Other suitable ranges include about 5 wt % to about 20 wt %, about 5 w % to about 10 wt %, about 20 wt % to about 25 wt %, about 30 wt % to about 40 wt %. Other suitable values include about 5, 6, 7, 8, 9, 10, 12, 14, 16, 18, 20, 22, 24, 26, 28, 30, 32, 34, 36, 37, 38, and 40 wt % based on the total weight of the first slurry.

The silicate flotation collector compound can be an amine-based compound. For example, the silicate flotation collector can be one or more of primary amines, dialkyl amines, tertiary amines, and quaternary amines. Specific compounds examples include, but are not limited to, tallow, coco amines, hydroxyethyl alkyl imidazoline, lauryl amine, long chain alkyl pyridinium, and n-alkyl trimethyl ammonium. Silicate flotation collector compounds are commercially available and can include one or more of Flotigam® 3135 (Clariant), Flotigam® K2C (Clariant), Armak® 1019 (Akzo Nobel Surface Chemistry, LLC), MD 20763 (Akzo Nobel), CustAmine® 1208, (ArrMaz) and Tomamine® DA-17 (Evonik Industries), Ethomeen® (Akzo Nobel), and Duomac-T® (Akzo Nobel).

The silicate flotation collector compound can be provided in the first slurry in an amount of about 0.1 wt % to about 0.3 wt % based on the dry mass of the lime mud cake.

### Heat Aging Methods

In accordance with embodiments, a method for making precipitated calcium carbonate from lime mud can include heat aging the lime mud in sodium carbonate to reduce the high specific surface area impurities. In embodiments, the method can include admixing the lime mud cake with water, and sodium carbonate to form a first slurry, and heating the first slurry under conditions to age the slurry and form one or more of pirssonite (Na₂Ca(CO₃)₂ 2H₂O, shortite (Na₂Ca₂(CO₃)₃, and gaylussite (Na₂Ca(CO₃)₂.5H₂O). The method can further include separating a solid portion from the aged slurry and washing the solid portions under conditions to decompose the one or more of pirssonite, shortite, and galyussite to a CaCO₃ solid fraction and a Na₂CO₃ solution fraction and to remove sodium salts. The CaCO₃ solid fraction can then be admixed with water and a dispersant to disperse the CaCO₃ solid fraction in water and form a dispersed slurry having a Brookfield viscosity of less than about 100 cps at 100 rpm. Unless specified otherwise, viscosity values reported herein are Brookfield viscosity values. The CaCO₃ solid fraction is a purified precipitated calcium carbonate having a suitable specific surface area for use in papermaking applications, for example.

If needed for a desired application, the dispersed slurry can then be milled to a median particle size of about 0.5 microns to about 5 microns, and/or the pH can be adjusted to a pH of about 8 to about 11. For example, the pH can be about 9 to about 10, or about 9 to about 10.5, or about 8 to about 10, or about 8 to about 11. Other suitable pH values include about 8, 8.5, 9, 9.5, 10, 10.5, and 11.

In embodiments, the process can include washing the first slurry prior to heat aging. The first slurry can be washed for example, using a filter press, a clarifier and/or rotary vacuum filter. In embodiments, the washing can be accomplished using water. For example, an amount of water equal to about 1 to about 5 times the dry mass of the solids of the first slurry can be used.

In embodiments, the heat aging can be done by heating the slurry to a temperature of about 80° C. to about 130° C., about 90° C. to about 100° C., about 85° C. to about 95° C., or about 80° C. to about 90° C. Other suitable temperatures include about 80, 85, 90, 95, 100, 105, 110, 115, 120, 125, and 130° C.

In embodiments, the slurry can be aged for about 2 hours to about 8 hours, about 2 hours to about 4 hours, about 3 hours to about 7 hours, about 5 hours to about 8 hours, or about 3 hours to about 6 hours. Other suitable times include about 2, 3, 4, 5, 6, 7, or 8 hours.

In embodiments, the first slurry can include about 20 wt % to about 40 wt % sodium carbonate based on the total weight of the first slurry. Other suitable amounts of sodium carbonate include about 25 wt % to about 40 wt %, about 30 wt % to about 35 wt %, about 20 wt % to about 30 wt %, or about 25 wt % to about 35 wt %. For example, the first slurry can include about 20, 22, 24, 26, 28, 30, 32, 34, 36, 38, or 40 wt % based on the total weight of the first slurry.

In embodiments, the first slurry can include about 5 wt % to about 30 wt % lime mud, based on the total weight of the first slurry. Other suitable amounts of lime mud include about 5 wt % to about 15 wt %, about 10 wt % to about 20 wt %, about 15 wt % to about 30 wt %. For example, the first slurry can include about 5, 6, 7, 8, 9, 10, 11, 12, 13, 14, 15, 16, 17, 18, 19, 20, 21, 22, 23, 24, 25, 26, 27, 28, 29, or 30 wt %.

In embodiments, after being separated from the aged slurry, the solid portion is washed with water. Washing can be done by passing water through a cake or paste using known equipment. For example, a filter press can be used. Alternatively, the solid portion can be resuspended in water and a separation process can be repeated. Other known washing techniques and equipment can be used.

In embodiments, the sodium carbonate used in the process can be recycled for subsequent use. However, prior to recycling in the process, dissolved silica present in the sodium carbonate from the process must be removed. This can be done, for example, by lowering the pH of the recovered sodium carbonate to about 9.5 to precipitate silica and filter out the precipitated silica using any suitable filtration method. In embodiments, the dissolved silica can be removed by admixing the recovered sodium carbonate with a sodium aluminate solution to precipitate aluminosilicate and then filtering out the aluminosilicate using any suitable filtration method as known in the art.

### Phase Separation Methods

In accordance with embodiments, a method for making a purified precipitated calcium carbonate from lime mud can include the use of phase separation to remove high specific surface area impurities. It was advantageously found that high specific surface area impurities can be phase separated from the calcium carbonate and removed to generate a purified precipitated calcium carbonate product.

In embodiments, the method can include admixing the lime mud cake with water and a dispersant to form a dispersed slurry having a viscosity of less than about 1000 cps at 100 rpm, adjusting the pH of the dispersed slurry to be a pH of about 8 to about 10.5. In embodiments, the dispersed slurry can have a viscosity of less than about 100 cps at 100 rpm. The method can further include milling the dispersed slurry to a median particle size of about 0.5 microns to about 5 microns. After milling, the pH can be readjusted if needed to be a pH of about 8 to about 10.5. The method can then include inducing a phase separation in the milled slurry using conditions sufficient to obtain slurry that includes impurity particles and a paste that includes the purified calcium carbonate. The paste can be separated from the centrate and dispersed in water to a target solid content to thereby produce the precipitated calcium carbonate.

In embodiments, the method can include admixing the lime mud cake with water to form a first slurry and the pH of the first slurry can be adjusted to be about 10 to about 11 and then inducing phase separation to separate out the impurities and generate a paste that includes the purified calcium carbonate. The paste can then be separated and admixed with water and a dispersant to form a dispersed slurry having a viscosity of less than about 1000 cps at 100 rpm. In embodiments, the dispersed slurry can have a viscosity of less than about 100 cps at 100 rpm. The dispersed slurry can be milled to a particle size of about 0.5 microns to about 5 microns and the pH can be adjusted to be about 9 to about 10.5. In such embodiments where milling is performed after the phase separation step, it was found a dispersant was not needed in the first slurry and could instead be added when forming the dispersed slurry of the purified precipitated calcium carbonate.

In any of the phase separation methods disclosed herein, centrifugation can be used as the phase separation method. For example, the method can include centrifuging the milled slurry under conditions sufficient to achieve a g-force of about 500 to about 2000 g for a residence time of about 1 to about 10 minutes to obtain a centrate slurry that includes the impurity particles and a paste that includes the purified calcium carbonate. The paste can be separated from the centrate and dispersed in water to a target solid content depending on the end use of the purified precipitated carbonate product.

In any of the phase separation methods disclosed herein gravity separation or other known phase separation techniques can be used to phase separate the impurities from the calcium carbonate. Gravity settling parameters such as time of settling and vertical liquid depth can be adjusted for a given slurry.

The first slurry can have a solids content of about 10 wt % to about 35 wt % based on the total weight of the slurry. Other suitable amounts include about 15 wt % to about 30 wt %, about 10 wt % to about 20 wt %, about 20 wt % to about 25 wt %, or about 10 wt % to about 30 wt %. For example, the first slurry can have a solids content of about 10, 12, 14, 16, 18, 20, 22, 24, 26, 28, 30, 32, 34, or 35 wt %.

In any of the foregoing embodiments, when diluting a paste or a slurry to form a dispersed slurry of the purified precipitated calcium carbonate, the dispersed slurry can have a solids content of about 25% to about 50% by weight based on the total weight of the dispersed slurry. Other suitable solids contents, by weight based on the total weight of the dispersed slurry, include about 25% to about 40%, about 30% to about 45%, about 30% to about 50%, or about 40% to about 50%. For example, the dispersed slurry can have a solids content by weight based on the total weight of the dispersed slurry of about 25, 26, 27, 28, 29, 30, 31, 32, 33, 34, 35, 36, 37, 38, 39, 40, 41, 42, 43, 44, 45, 46, 47, 48, 49, and 50%.

In any of the foregoing embodiments, the dispersant can be one or more of sodium poly(acrylic acid), a polycarboxylate homo or co-polymer of monomer units including acrylic, methacrylic, itaconic, maleic, fumaric, crotonic, hydroxyacrylic acids, and maleic anhydride.

### Hydrocyclone Processing for Removal of Black Char

Hydrocyclone processing can be used alone or in combination with any of the methods for removal of high specific surface area materials to remove black char from lime mud. When used in combination with methods of removal of high specific surface area materials, the removal of black char can be performed after the removal of the high specific surface area materials.

As noted above, the methods for removal of black char can be performed on the precipitated calcium carbonate resulting from the processing to remove high specific surface area impurities or on the lime mud cake. When used on the purified precipitated calcium carbonate after removal of high specific surface area impurities, the resulting product is generally a slurry of the purified precipitated carbonate with water and a dispersant. When used with a lime mud cake, the lime mud cake can be dispersed in water optionally with a dispersant to form a slurry for processing through the black char removal processes. Any of the dispersants described above can be used. For ease of reference, the term “black char removal starting slurry” will be used herein and shall be understood to refer to either a slurry of the prior processed precipitated calcium carbonate in which high specific surface area impurities were removed or a slurry formed from a lime mud cake.

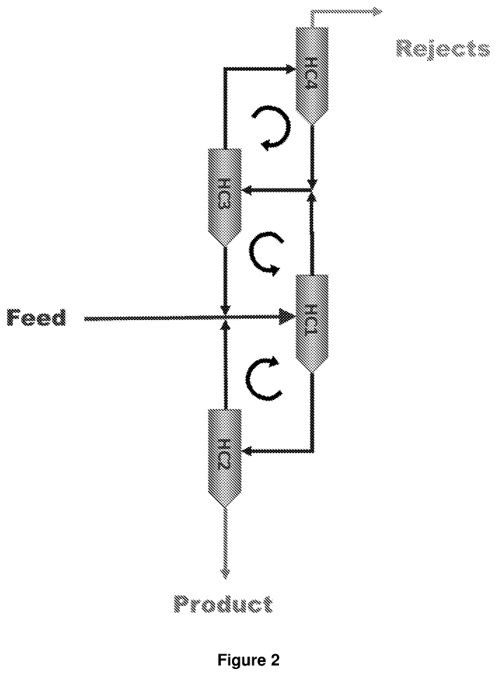

The black char removal starting slurry having water and dispersant as well as the black char impurity can be passed through an apparatus containing one to four hydrocyclones in series and/or parallel configuration. As the slurry passes through the apparatus, the black char impurity floats to the top of the slurry and can be removed. Referring to FIG. 2, in embodiments for example having four hydrocyclones, the process can include passing the slurry through a first hydrocyclone, where the overflow (lighter particles) passes to a third hydrocyclone and an underflow (heavier particles) passes to a second hydrocyclone. In the second hydrocyclone, the overflow passes to the first hydrocyclone, while the underflow passes to a recovery chamber. In the third hydrocyclone, the overflow passes to a fourth hydrocyclone and an underflow passes to the first hydrocyclone. In the fourth hydrocyclone, the overflow passes to waste, and the underflow passes to the third hydrocyclone.

### Trap Tank Processing for Removal of Black Char

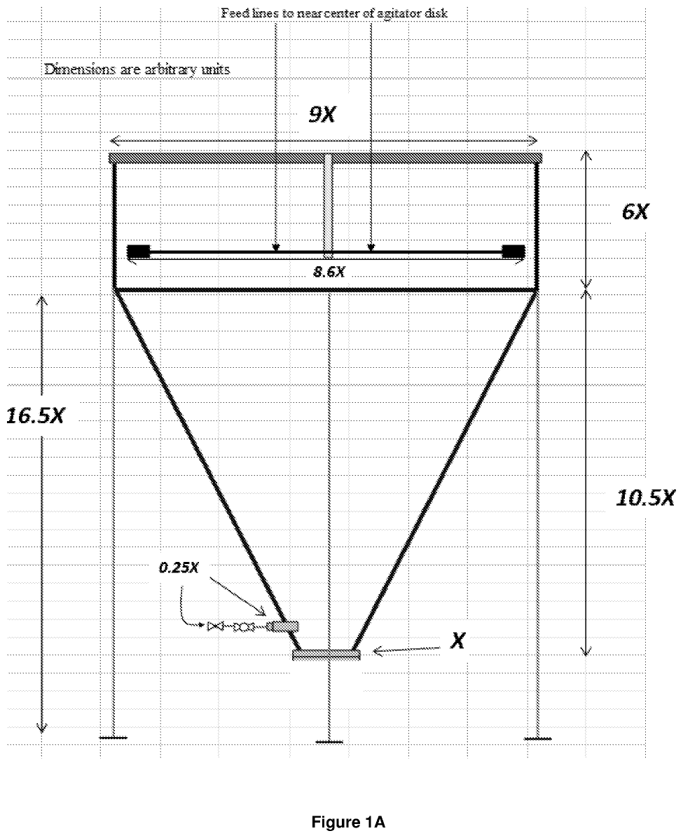

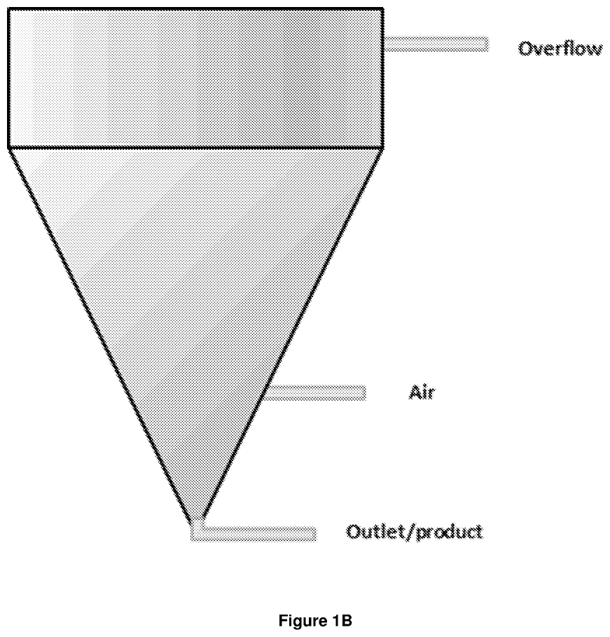

As an alternative to hydrocyclone processing, a trap tank process can be utilized for the removal of black char. Referring to FIGS. 1A and 1B, a schematic image of a trap tank is shown. The trap tank can have a generally conical shape. In the embodiment illustrated in FIGS. 1A and 1B, the trap tank has a top cylindrical portion disposed on a frustoconically shaped bottom portion. The trap tank can further include an overflow valve, a rotating blade, and an outlet. The overflow valve can be disposed in a top region of the trap tank where the slurry is fed into the trap tank to collect any overflow that may result, such as from having a feed rate that is higher than an output rate. Without intending to be bound by theory, it is believed that the trap tank design balances the tendency of black char to move upward in the slurry to the surface, against a slow downward flow of slurry. Agitation near the surface of the slurry enhances the separation of black char from lime mud particles.

In embodiments, such as illustrated in FIGS. 1A and 1B, the cylindrical portion can include feed lines for feeding the black char removal starting slurry from a feed tank or other receptacle and a rotating blade disposed at a lower portion of the cylindrical portion to agitate the slurry as it is fed into the trap tank. As the slurry in the trap tank is agitated, black char impurities rise to the surface with the purified sample residing at the bottom of the tank. An outlet pump can be included at the bottom of the trap tank to recover purified sample. In embodiments, the system can be run to maintain a constant or substantially constant flow of feed into the trap tank and purified sample out of the trap tank. In embodiments, the method can include running the recovered sample through the trap tank 1 or more times, 2 or more times, 3 or more times, 4 or more times, or 5 or more times. For example about 1 to about 3 times, about 2 to 5 times, about 1 to 4 times, and about 1 to 5 times. Once the feed/recovered sample has been run through the trap tank the desired number of times it can be collected in a recovery chamber. If necessary, the recovered product can be further processed to render it more suitable for use as a filler or pigment, such as by adjusting the pH and/or adjusting the solids content.

The agitator can be a flat disk-like blade, a dispersion blade, and/or a saw-blade impeller. The agitator can be any blade capable of achieving laminar flow in the slurry. In embodiments, the agitator can be a Cowles blade with diameter equal to about 0.4 to about 0.95 times the diameter of the cylindrical section of the trap tank.

The agitator can rotate at a rate of tip speed of about 0.1 to about 1.5 m/sec, maintaining laminar flow.

In embodiments, the slurry can have a residence time in the tank of about 2 to about 10 minutes, about 5 to about 8 min, about 4 to about 6 min, about 3 to about 7 min, or about 2 to about 9 min. Other suitable residence times include about 2, 3, 4, 5, 6, 7, 8, 9, or 10 minutes.

### Ozone Method for Removal of Black Char

In embodiments, black char can be removed by exposure of the black char removal starting slurry to ozone treatment. The black char removal starting slurry can be or include the precipitated calcium carbonate in a purified form resulting from any of the foregoing methods. Exposure to ozone can be done while agitating the black char removal starting slurry. Without intending to be bound by theory, it is believed that the ozone oxidizes the black char to carbon dioxide, which is then removed in the gas flow.

Any suitable device for generating and flowing ozone through the black char removal starting slurry can be used. Generating devices may use ultraviolet light, electric discharge or electrolysis. Ozone may be generated in flowing air or pure oxygen, or any mixture of the two. The air or oxygen can be flowed at a flow rate of about 0.1 to about 2 liters per minute of ozone-containing gas per liter of lime mud slurry. For example, a flow of about 1 liter per minute of dry air flow can be used for treating 675 mL lime mud slurry at 10% solids. The concentration of ozone in the air or oxygen stream may be in the range of about 2 g/m³ to 50 g/m³, about 25 g/m³ to about 50 g/m³, about 5 g/m³ to about 12 g/m³, about 2 g/m³ to about 15 g/m³, about 8 g/m³ to about 15 g/m³, or about 35 g/m³ to about 45 g/m³. Other suitable concentrations include about 2, 4, 6, 8, 10, 12, 14, 16, 18, 20, 22, 24, 26, 28, 30 32, 34, 36, 38, 40, 42, 44, 46, 48, and 50 g/m³.

The process can be done using any agitator design suitable for maximizing gas contact with liquid. For example, a radial flow or Rushton impeller can be used at tip speeds of about 1 m/sec to about 5 m/sec. The ozone reaction can be conducted at elevated temperature and elevated pH. For example, a temperature of 40° C. can be used. For example, temperatures of about 40° C. to about 80° C., about 50° C. to about 60° C., about 40° C. to about 60° C., about 50° C. to about 70° C., or about 45° C. to about 65° C. can be used. For example, a pH above pH 10 or above pH 11 can be used. Higher reaction rates with ozone are achieved at these conditions of higher temperature and pH, thus, enabling a shorter reaction time in the vessel.

### Flotation Method for Removal of Black Char

In embodiments, black char can be removed using flotation. The black char removal starting slurry can be mixed with a frother and a flotation collector compound. The mixture can be mixed with tip speeds of about 150 m/min to about 500 m/min, about 200 m/min to about 350 m/min, about 300 m/min to about 400 m/min or about 150 m/min to about 250 m/min, under airflow for 1 to 10 minutes with collection of the foam as it overflows. The black char is removed with the foam. The remaining tail slurry contained the purified precipitated calcium carbonate.

Suitable frothers include standard alcohols with hydrocarbon chains with 5 to 10 carbon atoms such as methyl isobutyl carbinol (MIBC), amyl alcohol, cresol and terpineol. Other frother types, such as polyalkoxy and polyglycol ethers can also be used. Any combination of one or more frothers can be used. Frothers can be used at levels of 10 to 250 ppm, or about 10 ppm to about 100 ppm, about 100 ppm to about 250 ppm frother per dry mass of lime mud. Other suitable values includes about 10, 15, 20, 25, 30, 35, 40, 45, 50, 55, 60, 65, 70 75, 80, 85, 90, 95, 100, 125, 150, 175, 200, 225, and 250 pp frother per dry mass of lime mud.

Suitable flotation collector compounds include kerosene, or other oily, water-immiscible compounds such as diesel oil. Collectors can be used at 100 to 1000 ppm, 200 to 500 ppm, about 150 to about 350 ppm, or about 700 ppm to about 1000 ppm collector per dry mass of lime mud. Other suitable values include about 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, and 1000 ppm collector.

The air flow can be about 1 standard liters per minute (SLPM) to about 6 SLPM, about 3 SLPM to about 5 SLPM, about 1 SPLM to about 2 SLPM, or about 4 SLPM to about 6 SLPM. Other suitable flow rates include about 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.8, and 6 SLPM

In any of the embodiments herein, the precipitated calcium carbonated product and/or slurry whether or not further processed for removal of black char can be admixed with any additives for formulating the precipitated calcium carbonate into a suitable formulation for use as a filler and/or pigment for a given papermaking application.

### EXAMPLES

### Example 1: Heat Aging (Ha) in Sodium Carbonate

A lime mud was processed to provide precipitated calcium carbonate material with reduced specific surface area and reduced impurity content as compared to the starting material. A lime mud cake was obtained as a waste product from a pulp mill. The lime mud cake was slurried in a 25-30% solution of sodium carbonate at 10-20% calcium carbonate solids content. In particular, in 1 kg slurry, 200 g CaCO₃ (20% CaCO₃), 240 g Na₂CO₃, 560 g H₂O (30% Na₂CO₃).

The slurry was then heat aged at 100° C. for 8 hours, forming the mixed salt, pirssonite (Na₂Ca(CO₃)₂.5H₂O). A comparison of the process without the heat aging step was performed, with the results outlined in the table below.

The slurry was then filtered or separated into solid and liquid phases by vacuum filtration using a Buchner funnel and paper. The cake was washed while in the Buchner funnel with three portions of water, each portion equal to the solid mass of the original lime mud cake. The solid portion was washed with water removed to remove sodium salts, which can be optionally recycled to the start of the process. This washing also decomposed the pirssonite back to CaCO₃ and Na₂CO₃.

The CaCO₃ solids were separated and dispersed in water at 35% solids, using a sodium poyl(acrylic acid) as a chemical dispersant. The dispersant was used to lower slurry viscosity to a Brookfield viscosity of less than about 100 cps at 100 rpm.

The pH of the milled slurry was adjusted to a pH of about 9.

To recycle the sodium carbonate solution, dissolved silica must first be removed and wash water needs to be separated out. Silica may be removed by either 1) lowering pH to about 9.5 with carbon dioxide gas to form precipitated silica, which is then filtered out; or 2) precipitation as an aluminosilicate with sodium aluminate solution, which is also filtered out. Water may be removed by evaporation or membrane processes such as reverse osmosis.

The resulting precipitated calcium carbonated formed by heat aging showed a significant reduction in the specific surface area and the amount of silicon dioxide present as compared to processing without an aging step.

| | Precipitated Calcium | Precipitated Calcium |
|---|---|---|
| | Carbonate Without | Carbonate after |
| | Heat Aging | Heat Aging |
| Specific Surface | 13.2 | 6.4 |
| Area (m²/g) | | |
| % SiO₂ | 3.47 | 1.44 |

### Example 2: Removal of Impurities Using Phase Separation

A lime mud cake, obtained as a waste product from the pulp mill, was slurried in water at 20% solids. The slurry was processed to remove excess white liquor from the pulp mill using a filter press with a wash cycle. The filter press was used to first form a cake from the 20% solids slurry and then water was forced through the cake. The wash cycle was performed using an amount of water that was four times the mass of the dry solids.

The washed cake was dispersed in water at 20% solids, using sodium poly(acrylic acid) as a chemical dispersant. The resulting dispersed slurry had a viscosity of about 10 cps at 100 rpm.

The dispersed slurry was then gassed with flue gas of about 15% carbon dioxide content to lower the pH to a pH of about 10.5.

The pH adjusted slurry was then milled to a desired particle size appropriate for use as a paper filling or coating pigment. In the present example, the pH adjusted slurry was milled using a vertical media mill running continuously and with a single pass through it. The resulting milled median particle size was about 3.5 microns.

The milled slurry pH was adjusted again by gassing with carbon dioxide gas to a pH of 9.5. The slurry was then continuously centrifuged at 1400 to 1500 rpm (see table) to obtain a g-force of 713 or 819 g for residence times of 4.8 to 8.4 min. The centrate containing fine particle impurities was removed and a paste containing purified product was separated for further processing.

Four samples were prepared by the foregoing method and the resulting paste from each sample had solids contents shown in the table below. The resulting precipitated calcium carbonate had a significant reduction of impurity elements such as silicon, aluminum, magnesium, and iron. Reductions of specific surface area and SiO₂ content are shown below as compared to the starting kiln lime mud.

| | Kiln Lime Mud | Kiln Lime Mud | Kiln Lime Mud | Kiln Lime Mud |
|---|---|---|---|---|
| | Feed - Sample 1 | Feed - Sample 2 | Feed - Sample 3 | Feed - Sample 4 |
| Specific Surface | 10.60 | 10.90 | 10.00 | 10.00 |
| Area (m²/g) | | | | |
| % SiO₂ (wt %) | 1.94 | 1.99 | 1.72 | 1.72 |
| | Final Processed | Final Processed | Final Processed | Final Processed |
| | Precipitated | Precipitated | Precipitated | Precipitated |
| | Calcium Carbonate | Calcium Carbonate | Calcium Carbonate | Calcium Carbonate |
| | Product - Sample 1 | Product - Sample 2 | Product - Sample 3 | Product - Sample 4 |
| rpm | 1500 | 1500 | 1400 | 1400 |
| Residence | 8.4 | 6.7 | 5.6 | 4.8 |
| Time (min.) | | | | |
| Solids content | 68.80 | 68.99 | 67.44 | 67.70 |
| (wt %) | | | | |
| Specific Surface | 7.7 | 8.0 | 7.8 | 6.9 |
| Area (m²/g) | | | | |
| % SiO₂ (wt %) | 1.36 | 1.25 | 1.23 | 1.20 |

### Example 3: Removal of Impurities Using Phase Separation on Lime Mud Before Milling

A lime mud cake, obtained as a waste product from a pulp mill, was slurried in water at 20% solids. The slurry was processed to remove excess white liquor in the liquid phase using a horizontal filter press with a wash cycle. The filter press was used to first form a cake from the 20% solids slurry, which resulting in a 65% solids cake, and then water was forced through the cake. The wash cycle was performed using an amount of water that was four times the mass of the dry solids.

The resulting washed cake was slurried in water at 23% solids then processed to lower pH to 10.9, by gassing with carbon dioxide containing flue gas.

The pH adjusted slurry was then continuously centrifuged at 1300 rpm to obtain a g-force of 615 with residence times varying as shown in the table. The centrate containing fine particle impurities was removed and a paste containing purified product was separate for further processing.

The resulting centrifuge paste was dispersed in water at 30% solids, using a sodium poly(acrylic acid) as a dispersant. The Brookfield viscosity of the dispersed slurry was 13 cps at 100 rpm. Four samples were prepared by the foregoing method as shown in the table below.

The resulting product had lower impurity elements such as silicon, aluminum, magnesium and iron. It also had reduced impurity phases such as calcium silicates, hydrotalcite and black char; and lower specific surface area

| | Kiln Lime Mud | Kiln Lime Mud | Kiln Lime Mud | Kiln Lime Mud |
|---|---|---|---|---|
| | Feed - Sample 1 | Feed - Sample 2 | Feed - Sample 3 | Feed - Sample 4 |
| Specific Surface | 10.00 | 10.00 | 10.00 | 10.00 |
| Area (m²/g) | | | | |
| % SiO₂ (wt %) | 2.23 | 2.23 | 2.23 | 2.23 |
| | Final Processed | Final Processed | Final Processed | Final Processed |
| | Precipitated | Precipitated | Precipitated | Precipitated |
| | Calcium Carbonate | Calcium Carbonate | Calcium Carbonate | Calcium Carbonate |
| | Product - Sample 1 | Product - Sample 2 | Product - Sample 3 | Product - Sample 4 |
| Residence | 5.6 | 4.2 | 3.4 | 2.8 |
| time (min.) | | | | |
| Solids content | 62.08 | 61.47 | 61.08 | 61.00 |
| (wt %) | | | | |
| Specific Surface | 7.8 | 8.08 | 7.8 | 7.54 |
| Area (m²/g) | | | | |
| % SiO₂ (wt %) | 1.68 | 1.7 | 1.72 | 1.64 |

### Example 4: Removal of Impurities Using Gravity Settling

The process of example 2 was repeated except instead of centrifugation a gravity settling process was utilized after milling. In particular, the centrifugation step of example 2 was replaced by allowing for settling in a test tube cylindrical container at the indicated liquid heights and settling times identified below. After the designated settling time, the top layer was poured off, removed, and the bottom layer was tested.

The gravity settling method resulted in some reduction of the specific surface area, which was believed to be caused by the reducing of impurities such as silicates.

| | Kiln Lime Mud | Kiln Lime Mud | Kiln Lime Mud |
|---|---|---|---|
| | Feed - Sample 1 | Feed - Sample 2 | Feed - Sample 3 |
| Specific Surface | 10.6 | 16.9 | 16.9 |
| Area (m²/g) | | | |
| | Final Processed | Final Processed | Final Processed |
| | Precipitated | Precipitated | Precipitated |
| | Calcium Carbonate | Calcium Carbonate | Calcium Carbonate |
| | Product - Sample 1 | Product - Sample 2 | Product - Sample 3 |
| Settling Time | 240 | 150 | 280 |
| (Min) | | | |
| Height of | 4 | 8 | 2.2 |
| liquid (cm) | | | |
| Bottom Layer | 6.9 | 11.0 | 10.9 |
| Specific Surface | | | |
| Area (m²/g) | | | |

### Example 4: Flotation to Remove Impurities from Lime Mud

A lime mud cake obtained as a waste product form a pulp mill was slurried in water at 20% solids. The slurry was then gassed with pure carbon dioxide to reduce the pH to the pH values shown in the table.

Flotigam® 3135 (CLARIANT) or CustAmine® 1208 (ARRMAZ), as a silicate-specific flotation collector, was added to the pH adjusted slurry. The table below indicates that dosage amounts based on the dry mass of the lime mud.

The slurry was then diluted to 8 wt % solids with water and processed through a flotation cell system such that a concentrate foam containing silicate particle impurities and a tail slurry containing purified product were obtained.

The tail slurry was then filtered to remove excess soluble salts in a liquid phase using a vacuum filter and paper. As a result of the processing, a paste containing purified CaCO₃ was obtained.

The resulting product contained lower impurity elements such as silicon, aluminum, magnesium and iron. It also had reduced impurity phases such as calcium silicates and hydrotalcite, and lower specific surface area. The table below shows the reduction of SiO₂ achieved by this method.

| | | Sample 1 | Sample 2 | Sample 3 | Sample 4 |
|---|---|---|---|---|---|
| | | (Ref F3) | (Ref F11) | (Ref F13) | (Ref F16) |
| pH | | 9 | 8 | 10 | 8 |
| Collector | | Flotigam 3135 | CustAamine 1208 | CustAamine 1208 | CustAamine 1208 |
| Collector dose | | 600 | 1800 | 1800 | 2700 |
| (g/ton) | | | | | |
| Feed Slurry | % SiO2 | 2.04 | 2.04 | 2.04 | 5.22 |
| | (wt %) | | | | |
| Flotation Tail | % SiO2 | 1.57 | 1.35 | 1.51 | 3.48 |
| | (wt %) | | | | |

### Example 5: Removal Black Char with Hydrocyclone Processing

A final product slurry consisting of 30% calcium carbonate in water, sodium polyl(acrylic acid) as a dispersant, and a black char impurity was further processed to remove the black char impurity. The slurry had a viscosity of 40 cps. The slurry was processed through an apparatus containing four hydrocyclones (HC) and as the slurry is passed through, the black char impurity floated to the top of the slurry and can be processed or separated from a purified recovered product (see FIG. 2). The overflow (lighter particles) and underflow (heavier particles) of each HC flows to the next as follows:

HC1 Overflow to HC3 Underflow to HC2

HC2 Overflow to HC1 Underflow to product

HC3 Overflow to HC4 Underflow to HC1

HC4 Overflow to waste Underflow to HC3

Qualitative observations showed the underflow of HC2 had less black char than the feed product.

### Example 6: Removal of Black Char with Trap Tank

A trap tank as illustrated in FIGS. 1A and 1B was used to separate out black char from a final product slurry containing 34.8% calcium carbonate in water, sodium poyl(acrylic acid) as a dispersant, and a black char impurity. The slurry had a Brookfield viscosity of 20 cps at 100 rpm.

The feed line in the trap tank was positioned just above the slurry level near the center of the agitator to maximize the retention time of the slurry above the blade. The feed and product flow pumps were adjusted such that a constant level was maintained in the trap tank. A double head peristaltic pump was used for the feed stream and the product flow stream.

The feed stream was started to fill the trap tank to the overflow port, and, using the double head pump, the product line was recycled back into the trap tank during filling. The agitator was turned on and set to an rpm as outlined in the table below. An air flow was supplied in some experiments as identified in the tables below. As illustrated in the table below, air flow was not found to aid separation. The table also provides the run times. In each of the experiments, the feed and product streams flowed for about 3 retention times. After the final pass through, the product was collected in a clean beaker. The product in the beaker was observed to determine qualitatively an amount of black char present in the product as compared to the trap tank and overflow tank.

All runs use a 1.65 liter trap tank with 4.9 inch inner diameter and either a 4.8 inch diameter flat blade or 4.0 inch diameter Cowles blade agitator. These runs demonstrate the need for low rpm agitation and slow feed rate.

| Run # | 1 | 2 | 3 | 4 | 5 | 6 | 7 |
|---|---|---|---|---|---|---|---|
| Agitator | Flat | Flat | Cowles | Cowles | Cowles | Cowles | Cowles |
| | blade | blade | | | | | |
| RPMs | 100 | 50 | 250 | 100 | 50 | 50 | 50 |
| Slurry | 250 | 250 | 200 | 200 | 200 | 400 | 800 |
| Feed | | | | | | | |
| Rate | | | | | | | |
| (mL/min.) | | | | | | | |
| Air Flow | 1 | 0 | 0 | 0 | 0 | 0 | 0 |
| (slpm) | | | | | | | |
| Run Time | 20 | 20 | 20 | 20 | 25 | 13 | 6.4 |
| (min.) | | | | | | | |
| Black char | N | Y | N | N | Y | N | N |
| separated? | | | | | | | |
| (Y/N) | | | | | | | |

### Example 6: Remove Black Char with Ozone Treatment

A 10% solids lime mud slurry was prepared from a lime mud by dilution with water.

Approximately 625 ml of the lime mud slurry was poured into a 1 liter bottle with a hole cut in the lid for an R100 agitator and another hole cut in the top to deliver Ozone via a SS tube. The slurry was mixed at 730 rpm. The valve on a dry air cylinder was opened to feed the Ozone generator at a pressure of 10 psi. Dry air flow was supplied at 11 pm. The Ozone generator (Model 1 KNT purchased from Oxidation Technologies) was operated to an Ozone level of 100%. Without intending to be bound by theory, it is believed that the ozone reacts with the black char oxidizing it to carbon dioxide which is then removed with the gas flow.

After treatment, the Hunter and ISO dry brightness was tested, and pictures of the slurry face were taken with a camera to determine % Black Spot Area using ImageJ software. TGA-DSC analysis was performed.

| | % Black Area by | ISO Dry Brightness | Ppm organic |
|---|---|---|---|
| Sample | image analysis | (R457) | by TGA-DSC |
| Control - | 0.33 | 89.35 | 750 |
| no ozone | | | |
| 20 min. ozone | 0.29 | 89.69 | 480 |
| 6 hours ozone | 0.035 | 90.17 | 420 |

### Example 7: Remove Black Char Using Flotation

A 10% solids lime mud slurry was made by dilution of ˜70% solids filter cake with water.

200 or 500 ppm kerosene collector was added to the slurry and mixed for 2 minutes.

100 or 250 ppm MIBC (methyl isobutyl carbinol) frother was then added and the mixture was mixed for 0.5 minute.

The mixture was then mixed 2000 or 1500 rpm, under an air flow of 4 standard liters per minute. Mixing continued to aerate for 5 or 10 minutes while collecting foam as it overflowed.

The collected foam was tested for brightness as an indication of black char content. The remaining tail slurry contained the purified CaCO₃ with reduced black char.

| | ISO Dry Brightness | Ppm organic |
|---|---|---|
| Sample | (R457) | by TGA-DSC |
| Control - | NA | 60-80 |
| no flotation | | |
| Foam | 65 | 800-1000 |
| Tail | 76 | <30 |

Use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict embodiments for purposes of illustration only. One of ordinary skill in the art will readily recognize from the following discussion that alternative embodiments of the structures and methods illustrated herein may be employed without departing from the principles described herein.

Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method for making a purified precipitated calcium carbonate from lime mud, comprising:
admixing a lime mud cake with water and sodium carbonate to form a first slurry;
heating the first slurry under conditions to age the slurry and form one or more of pirssonite, shortite, and gaylussite;
separating a solid portion from the aged slurry;
washing the solid portion under conditions sufficient to decompose the one or more of pirssonite, shortite, and gaylussite to a CaCO₃ solid fraction and Na₂CO₃ solid fraction and to remove sodium salts; and
admixing the CaCO₃ solid fraction with water and a dispersant to disperse the CaCO₃ solid fraction in water and form a dispersed slurry having a Brookfield viscosity of less than about 1000 cps at 100 rpm, thereby producing a dispersed slurry containing the purified precipitated calcium carbonate.

2. The method of claim 1, further comprising milling the dispersed slurry to a median particle size of about 0.4 microns to about 5 microns.

3. The method of claim 2, further comprising adjusting the pH of the milled slurry to a pH of about 9 to about 10.5.

4. The method of claim 1 or 2, further comprising adjusting the pH of the dispersed slurry to a pH of about 9 to about 10.5.

5. The method of any one of the preceding claims, comprising heating the slurry to a temperature of about 80° C. to about 100° C. for about 2 to about 8 hours.

6. The method of any one of the preceding claims, wherein the first slurry comprises about 20 wt % to about 40 wt % sodium carbonate and about 5 wt % to about 40 wt % lime mud cake based on the total weight of the first slurry.

7. The method of any one of claims 1 to 3, further comprising:
collecting the sodium carbonate solution fraction;
removing dissolved silica from the collected sodium carbonate solution fraction to form a treated sodium carbonate, by:
lowering the pH to about 9.5 to precipitate silica and filtering out the precipitated silica, or
admixing the removed sodium salts with a sodium aluminate solution to precipitate aluminosilicate and filtering out the precipitated aluminosilicate,
where the treated sodium carbonate is recycled for use in a subsequent method of making a precipitated calcium carbonate from lime mud.

8. A method for making a purified precipitated calcium carbonate from lime mud, comprising:
admixing a lime mud cake with water and a dispersant to form a first slurry having a Brookfield viscosity of less than about 1000 cps at 100 rpm;
milling the first slurry to a median particle size of about 0.4 microns to about 5 microns;
phase separating the milled slurry under conditions sufficient to obtain a centrate slurry comprising impurity particles and a paste comprising a purified calcium carbonate; and
diluting the paste in water to a target solids content to thereby produce a dispersed slurry containing the purified precipitated calcium carbonate.

9. The method of claim 8, further comprising adjusting the pH of the dispersed slurry to a pH of about 8 to about 10 and/or adjusting the pH of the milled slurry to a pH of about 8 to about 10.

10. The method of claim 8 or claim 9, wherein phase separating comprises centrifuging the milled slurry at a g-force of about 500 g to about 2000 g for a residence time of about 1 minute to about 10 minutes.

11. The method of claim 8 or claim 9, wherein phase separating comprises gravity settling the milled slurry.

12. The method of claim 11, wherein the gravity settling is performed for a settling time of about 2 to 8 hours to a settling depth of about 2 cm to about 3000 cm.

13. The method of claim 8, further comprising, prior to forming the dispersed slurry, admixing the lime mud cake with water to form a first slurry and washing first slurry to remove caustic soda present in the lime mud cake.

14. The method of any one of claims 8 to 13, wherein the first slurry has a solids content of about 25 wt % to about 50 wt %.

15. A method for making a purified precipitated calcium carbonate from lime mud, comprising:
admixing a lime mud cake with water to form a first slurry;
adjusting the pH of the first slurry to be about 10 to about 11;
centrifuging the first slurry under conditions sufficient to achieve a g-force of about 500 to about 2000 g for a residence time of about 1 to about 10 minutes to obtain a centrate slurry comprising impurity particles and a paste comprising a purified calcium carbonate; and
admixing the paste with water and a dispersant to form a dispersed slurry having a Brookfield viscosity of less than about 1000 cps at 100 rpm and containing the purified precipitated calcium carbonate.

16. The method of claim 15, further comprising milling the dispersed slurry to a median particle size of about 0.4 microns to about 5 microns.

17. The method of claim 16, further comprising adjusting the pH of the milled slurry to be about 9 to about 10.5.

18. The method of any one of claims 8 to 17, further comprising adjusting the pH of the dispersed slurry to be about 9 to about 10.5.

19. The method of any one of claims 15 to 18, wherein the first slurry has a solids content of about 10% to about 25%.

20. A method for making a purified precipitated calcium carbonate from lime mud, comprising:
admixing a lime mud cake with water to form a first slurry;
adjusting the pH of the first slurry to be about 8 to about 11;
admixing the first slurry with a silicate flotation collector compound to form a second slurry;
processing the second slurry through a flotation cell system under conditions sufficient to form a concentrate foam containing silicate particle impurities and a tail slurry containing CaCO₃;
washing and separating the tail slurry into a liquid phase containing excess soluble salts and a paste containing purified CaCO₃; and
admixing the paste with water to form a dispersed slurry having a viscosity of less than about 100 cps at 100 rpm and containing the purified precipitated calcium carbonate.

21. The method of claim 20, wherein either the first slurry is formed to a solids content of about 5% to about 15% or the second slurry is diluted with water to a solids content of about 5% to about 15% before being processed through the flotation cell system.

22. The method of claims 20 to 21, further comprising milling the dispersed slurry to a median particle size of about 0.4 microns to about 5 microns.

23. The method of claim 22, further comprising adjusting the pH of the milled slurry to be about 9 to about 10.5.

24. The method of any one of claims 20 to 23, further comprising adjusting the pH of the dispersed slurry to be about 9 to about 10.5.

25. The method of any one of claims 20 to 24, wherein the first slurry has a solids content of about 20% to about 25%.

26. The method of any one of claims 20 to 25, wherein the silicate flotation collector compound is provided in an amount of about 0.1 wt % to about 0.3 wt % based on the dry mass of the lime mud cake.

27. The method of any one of claims 20 to 26, wherein the silicate flotation collector compound is amine-based.

28. The method of claim 27 wherein the silicate flotation collector compound is one or more of primary amines, dialkyl amines, tertiary amines, and quaternary amines.

29. The method of claim 28, wherein the silicate flotation collector is one or more of tallow, coco amines, hydroxyethyl alkyl imidazoline, lauryl amine, long chain alkyl pyridinium, and n-alkyl trimethyl ammonium.

30. The method of any one of the preceding claims wherein the dispersed slurry has a solids content of about 25% to about 50%.

31. The method of any one of the preceding claims, wherein the dispersant is one or more of sodium poly(acrylic acid), polycarboxylate homo or co-polymer of monomer units including acrylic, methacrylic, itaconic, maleic, fumaric, crotonic, hydroxyacrylic acids, and maleic anhydride.

32. The method of any one of the preceding claims, wherein the lime mud cake is generated as a pulp mill waste byproduct, sugar beet production byproduct, or the byproduct of acetylene production.

33. The method of any one of the preceding claims, further comprising adjusting pH with carbon dioxide gas and/or carbon dioxide containing gas.

34. A method of removing black char from a starting slurry containing calcium carbonate and black char, comprising:
flowing a starting slurry into a first hydrocyclone under conditions sufficient to cause black char particles to rise to a top portion of and form a first overflow and the calcium carbonate to remain at a bottom portion to form a first underflow;
flowing the first underflow to a second hydrocyclone under conditions sufficient to cause black char particles to rise to a top portion and form a second overflow and the calcium carbonate to remain at a bottom portion to form a second underflow;
flowing the first overflow to a third hydrocyclone under conditions sufficient to cause black char particles to rise to a top portion and form a third overflow and the calcium carbonate to remain at a bottom portion to form a third underflow;
flowing the second underflow to a recovery chamber;
flowing the second overflow to the first hydrocyclone;
flowing the third underflow to the first hydrocyclone;
flowing the third overflow to a fourth hydrocyclone under conditions sufficient to cause black char particles to rise to a top portion and form a fourth overflow and the calcium carbonate to remain at a bottom portion to form a fourth underflow;
flowing the fourth overflow to a waste container; and
flowing the fourth underflow to the third hydrocyclone.

35. A method of removing black char from a starting slurry containing calcium carbonate and black char, comprising:
flowing a starting slurry into a hydrocyclone under conditions sufficient to cause black char particles to rise to a top portion of and form an overflow and the calcium carbonate to remain at a bottom portion to form an underflow;
flowing the overflow to waste; and
flowing the underflow to a recovery chamber.

36. A method of removing black char from a starting slurry containing calcium carbonate and black char, comprising:
flowing a starting slurry into a first hydrocyclone under conditions sufficient to cause black char particles to rise to a top portion of and form a first overflow and the calcium carbonate to remain at a bottom portion to form a first underflow;
flowing the first underflow to a second hydrocyclone under conditions sufficient to cause black char particles to rise to a top portion and form a second overflow and the calcium carbonate to remain at a bottom portion to form a second underflow;
flowing the first and second overflows to waste; and
flowing the second underflow to a recovery chamber.

37. A method of removing black char from a starting slurry containing calcium carbonate and black char, comprising:
loading the starting slurry into a trap tank using a continuous inflow at or near a center of the trap tank;
agitating the starting slurry in the trap tank using an agitator at a tip speed of about 0.1 m/sec to about 1.5 m/sec for a residence time of about 4 to about 10 min and under conditions sufficient to cause black char particles to rise to a top portion of the trap tank and calcium carbonate to settle to a bottom portion of the trap tank; and
pumping the calcium carbonate from the bottom portion of the trap tank to a recovery container.

38. The method of claim 37, wherein the residence time is about 6 min to about 10 min.

39. The method of claim 38, wherein the residence time is about 8 min to about 10 min.

40. The method of any one of claims 37 to 39, wherein the tip speed is about 0.1 m/sec to about 0.2 m/sec.

41. A method of removing black char from a starting slurry containing calcium carbonate and black char, comprising:
flowing an ozone containing gas through the starting slurry at a flow rate per liter of starting slurry of about 0.1 liters per min to about 2 liters per min with an agitator at a tip speed of about 1 m/sec to about 5 m/sec, wherein the black char is oxidized by the ozone to carbon dioxide gas and removed with a gas flow.

42. The method of claim 41, wherein the concentration of ozone in the ozone-containing gas is about 2 g/m³ to about 50 g/m³.

43. The method of claim 41 or 42, wherein the starting slurry is heated to elevated temperature of about 40° C. to about 60° C. during flowing of the ozone containing gas through the starting slurry.

44. The method of any one of claims 41 to 43, wherein a pH of the starting slurry is adjusted to a pH above 10 during flowing of the ozone containing gas through the starting slurry.

45. A method of removing black char from a starting slurry containing calcium carbonate and black char, comprising:
admixing the starting slurry with a frother and a flotation collector compound to form a second slurry;
processing the second slurry through a flotation apparatus under an air flow per liter of second slurry of about 1 slpm to about 3 slpm and with an agitator at tip speeds of about 150 m/min to about 500 m/min for about 1 min to about 10 min, a foam which overflows from the flotation apparatus and a tail slurry which remains in the flotation apparatus, the foam comprising the black char and the tail slurry comprising the calcium carbonate; and
collecting the tail slurry and dispersing the tail slurry in water to form a dispersed slurry containing the calcium carbonate.

46. The method of claim 45, wherein the flotation collector is present in an amount of about 100 to about 1000 ppm.

47. The method of claim 45 or 46, wherein the flotation collector compound is one or more of kerosene or diesel oil.

48. The method of any one of claims 45 to 47, wherein the starting slurry is a lime mud cake dispersed in water and optionally a dispersant.

49. The method of any one of claims 34 to 48, wherein the starting slurry is purified slurry containing calcium carbonate after processing for removal of high specific area impurities.
